(19) United States
(12) Patent Application Publication
(10) Pub. No.: US 2002/0143870 A1
(43) Pub. Date: Oct. 3, 2002

(54) Method and system for providing interactive content over a network

(75) Inventor: Franz G. Rau, Redmond, WA (US)

Correspondence Address: MERCHANT & GOULD PC, P.O. BOX 2903, MINNEAPOLIS, MN, 55402-0903, US

(73) Assignee: Overthehedge.net, Inc.

(21) Appl. No.: 09/755,648

(22) Filed: Jan. 5, 2001

(51) Int. Cl. G06F 15/16

(52) U.S. Cl. 709/204; 709/205

(57) ABSTRACT

A method and system for providing an interactive show over a network is provided. The show is run in a way that is similar to a call-in radio show and utilizes a low-bandwidth audio stream synchronized with URLs that may be selected by the users. A small production crew takes calls, researches each caller's question, and displays relevant pictures and text to users across the network as the show's host takes the call. Not only do users hear the host of the show they also see pictures illustrating the topics being discussed. Users have the ability to respond to the show's host and refer to the pictures that are downloaded within the broadcast window. They may interact with portions of the media to obtain more information on a particular item without leaving the show.

### FIELD OF THE INVENTION

The present invention relates to software, and more particularly, to software that provides interactive content over communication networks.

### BACKGROUND OF THE INVENTION

The Internet has seen expansive growth over the last several years. Not only are there more Web sites providing a wide range of information, service, and goods, there are more “non-technical” users on the Internet than ever before.

Today, users may purchase goods, access the world's news as it happens, read reviews, or access a variety of resources for learning all on the Internet. For example, a user may learn about car repair, home repair, art, or a vast array of other topics.

Internet users are also exposed to different media types while visiting a Web site. Not only may users access textual information, they may also view videos complete with audio that may be streamed or downloaded. This media, however, is overwhelming to many of the users. Users also have trouble from choosing between the sites available. With so many available options, sites are in a constant struggle to keep and attract visitors.

Many sites invest significant time and money to create and promote a Web site, but many of these sites find that the visitors are not staying long enough to buy any products or influence any purchasing decisions.

Additionally, many sites are very informative but do not stand out. While many sites may rely on streaming media to send information to their customers they are waiting for broadband to become readily available to all users. Today, the majority of the business community has access to broadband, but more than 90 percent of home users connect to the Internet through a dial-up modem.

### SUMMARY OF THE INVENTION

The present invention is directed at addressing the above-mentioned shortcomings, disadvantages, and problems, and will be understood by reading and studying the following specification.

One aspect of the invention provides an interactive show over a network. The show is run in a way that is similar to a call-in radio show. A small production crew takes calls, researches each caller's question, and displays relevant pictures and text to users across the network as the show's host takes the call.

According to another aspect of the invention, users see pictures illustrating the topics being discussed on the show. Callers have the ability to respond to the show's host and refer to the pictures that are downloaded within the broadcast window. Users can stop or start the Web show any time they wish.

According to another aspect of the invention, users may select portions of the media downloaded to obtain more information about a particular item. If a portion of the media is selected, the information is provided to the user without the user having to leave the host's site. Once finished interacting with the media, the user simply continues as a user within the show.

According to yet another aspect of invention, users can stop or start the show any time they wish. They can also view the most current archived show. If a live show is being broadcast, they can view the current show, and contact the show with their questions.

In yet another aspect, the show consists of the voice of an expert in the particular subject and phone-in callers, synchronized with Web pages that illustrate the caller's problems, solutions, and related products. The show is live and uses a low-bandwidth audio stream synchronized with URLs targeted to load in a specific frameset within the host's Web site.

According to yet another aspect, the Web show includes pre-produced commercial segments. These commercial segments allow users to see/hear commercials, including “click through” to the advertiser, without ever leaving the original site.

### BRIEF DESCRIPTION OF THE DRAWINGS

FIG. 1 shows a logical flow diagram illustrating an overview of a network show providing interactive media;

FIG. 2 shows a flowchart illustrating a user connecting to a show;

FIG. 3 shows a flowchart illustrating a user contacting a show to ask a question;

FIG. 4 displays a flow chart illustrating a call screening process;

FIG. 5 is an exemplary screen diagram of a call screener interface according to one embodiment of the invention;

FIG. 6 shows a flow chart of a producer process;

FIG. 7 is an exemplary screen diagram of a producer interface according to one embodiment of the invention;

FIG. 8 is a flowchart illustrating searching for media to be included in a broadcast record;

FIG. 9 is a flowchart illustrating a user selecting a portion of the interactive media they are viewing;

FIGS. 10-22 illustrate exemplary screen displays according to an embodiment of the invention;

FIG. 23 shows a representative section of the Internet;

FIG. 24 depicts several components of a client computer; and

FIG. 25 depicts several of key components of a WWW server.

### DETAILED DESCRIPTION OF THE PREFERRED EMBODIMENT

In the following detailed description of exemplary embodiments of the invention, reference is made to the accompanying drawings, which form a part hereof, and in which is shown by way of illustration, specific exemplary embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the present invention is defined only by the appended claims.

Briefly stated, the present invention is directed at providing a method, system and apparatus for providing live interactive content over a network. According to one embodiment, a user can hear live audio, listen to live questions from audience participants, interact with a host, and see visuals/video of the relevant topic. Users can also see/hear commercials, including “click through” to the advertiser, without ever leaving the original site.

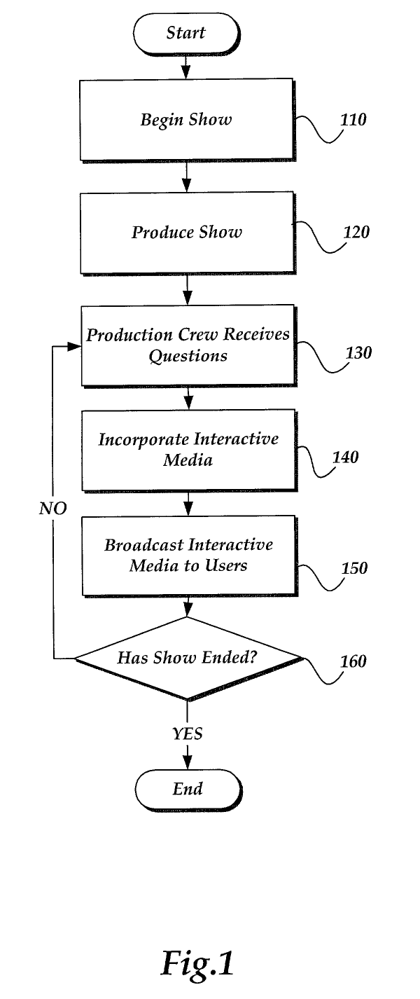

FIG. 1 shows a logical flow diagram illustrating an overview of a network show providing interactive media. At block 110, a networked show begins. In one embodiment of the invention, users participate in a networked show referred to as a “Webcast” on the Internet. The Webcast is similar to a radio talk show in its format but provides live interactive media to users connected to the show. The networked show may be produced in many different formats. For example, the show may be in the format of a call-in show, a seminar, or an infomercial type show. Additionally, the show may be broadcast to a single user or to an unlimited audience.

Advancing to block 120, the show is produced by a production crew of varying size. According to one embodiment of the invention, a crew of three to six people produces the show. The crew includes: one to three call screeners, a producer, an on-air host, and a sound/technical engineer. The production crew utilizes a live-broadcast authoring application to track callers, assemble and preview pages from the solutions database, and insert URLs for those pages and commercials into a broadcast stream. In one embodiment of the invention, the live-broadcast authoring application is ASP-based and has interfaces tailored for three differing job types: the call screener, the producer, and the on-air host.

Advancing to block 130, the crew receives questions from users. The users may either be connected to the show or not connected to the show. Preferably, the questions received are related to the content of the particular show. Accordingly, a call screener may screen callers to help ensure that the questions asked by the user will be of relevance to the particular topic of the show.

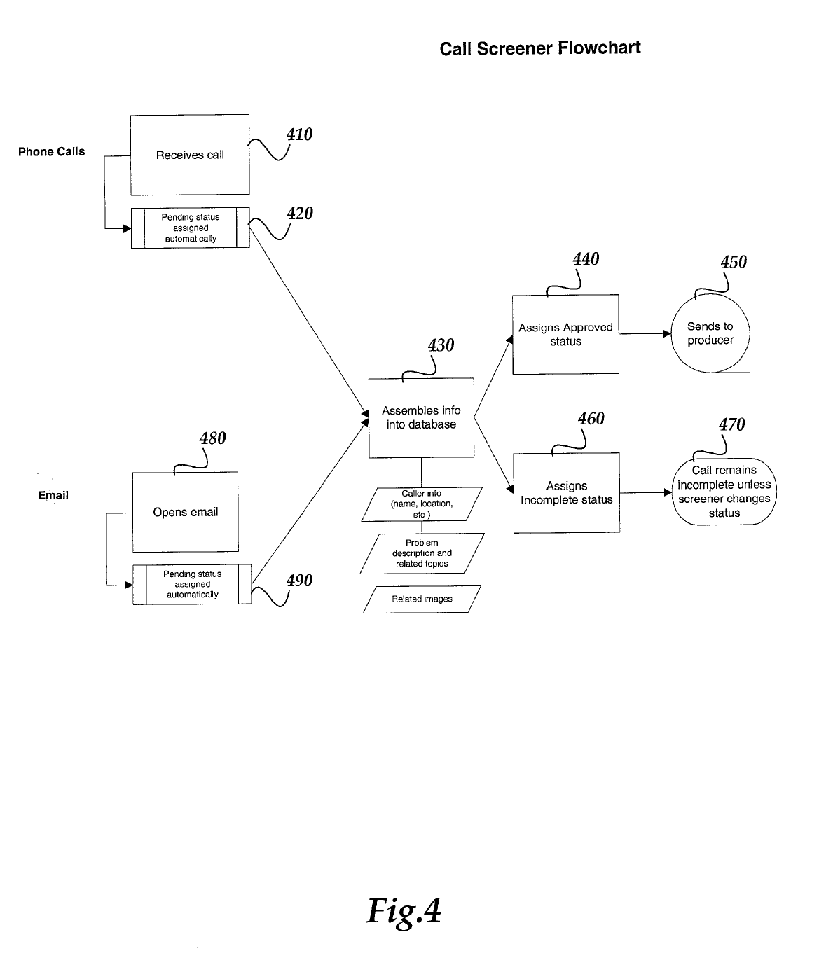

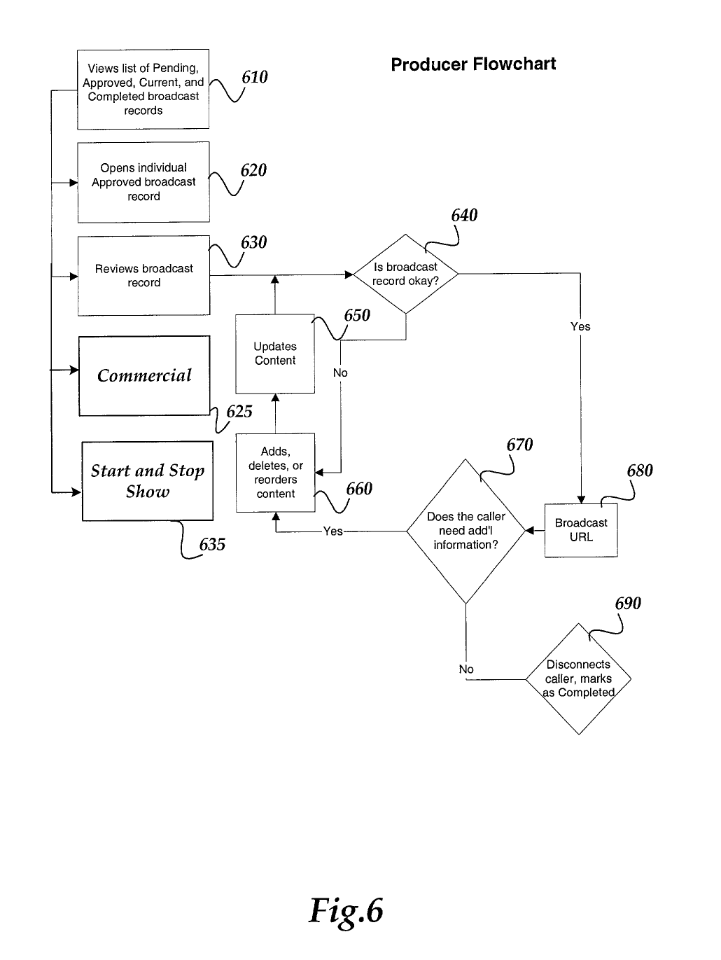

In response to the particular question or subject, interactive media is incorporated into a broadcast stream at block 140 to provide to the users (See FIGS. 4, 6 and related discussion). The media incorporated into the broadcast may be graphical pictures, textual documents, videos, and the like.

Moving to block 150, the selected media is broadcast to users connected to the show. The media may include interactive links to information a particular user may find of interest. The links provide the user the ability to access more data on a particular subject being discussed in the show without interrupting the show or requiring the user to leave the host's site.

Decision block 160 determines if the show has ended and, if so, the logical flow ends. The show may last for a particular period of time, may continue indefinitely, may continue until there are no more questions, or may continue for some other period of time. If the show has not ended, the logical flow returns to block 130 and the crew continues receiving questions.

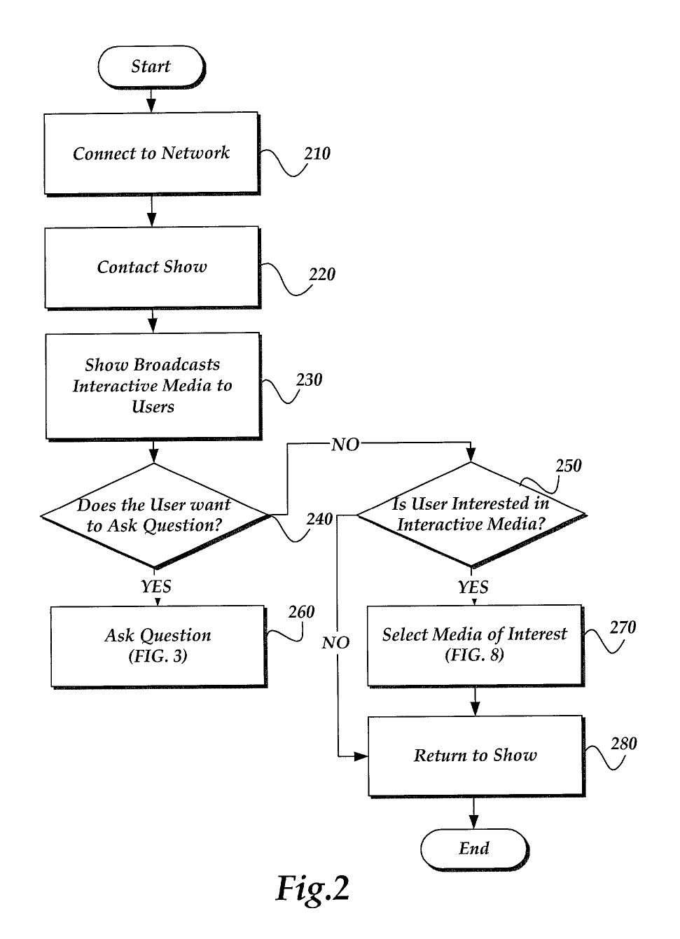

FIG. 2 shows a flowchart illustrating a user connecting to a show. Starting at block 210, a user connects to a network on which the show is broadcast. In one particular embodiment of the invention, the user logs onto the Internet through an Information Service Provider (ISP). In other embodiments, the user connects to wireless networks, local networks, and the like.

Moving to block 220, the user contacts the show. In one embodiment, the user contacts the show by accessing the host's website. In other embodiments, the user may access the show on his wireless device, may call in on a land-based telephone line, or access the show utilizing some other device known to those skilled in the art.

Advancing to block 230, interactive media is broadcast to users connected to the show. Typically, the interactive media is assembled based on users questions to the host of the show. The interactive media broadcast to the users may also be established in advance of the show. For example, the media can be established in advance of an instructional show on using a particular device. In one embodiment of the invention, the media is streamed to the user using standard streaming techniques.

Streaming media provides flexibility to the client system to be able to switch between different events because the entire media is not downloaded at one time. Rather, the media is buffered on the user's machine and then played to the user. Buffering allows most interruptions to not impede the flow of the streaming media. In one particular embodiment, the buffering amount is ten (10) seconds. This buffering amount may be changed to different times and can include decisions for buffering time based on the user's connection, speed of the network, and the like.

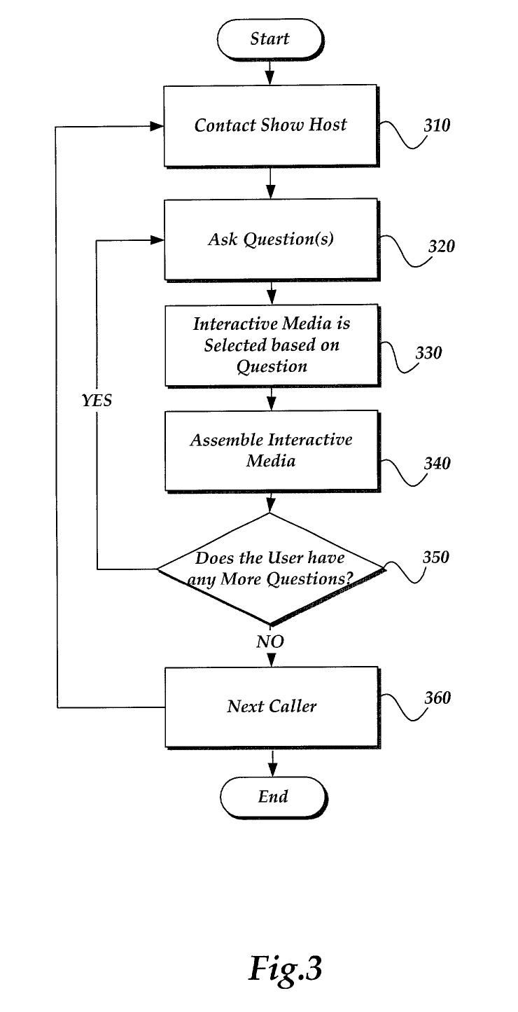

Decision block 240 determines if a user has any questions for the show. If the user does want to ask a question, then the logical flow moves to block 260 at which point the user contacts the production crew to ask their question (See FIG. 3 and related discussion).

If the user does not want to ask a question, decision block 250 determines if the user is interested in a specific portion of the interactive media broadcast to the user. For example, a product may be displayed that the user wants more information on. If the user is interested, the user selects the interactive media of interest (block 270). Otherwise, the user may continue watching/hearing the interactive media as it is broadcast (block 280).

If the user selects a portion of the interactive media, more information is provided to the user. This information may include interactive media, links to other sites, textual information, audio information, videos, and the like. At no point during this information exchange does the user ever leave the host's site. The show continues being broadcast to the user. Advancing to block 280, the user may stop viewing/hearing the additional media at any point and return to the show.

FIG. 3 shows a flowchart illustrating a user contacting a show to ask a question. According to one embodiment of the invention, the user calls the show using a telephone or e-mails the question. In alternative embodiments, the user may use a chat program, send in questions through mail, or leave questions in a voice mail box (block 310). The user may transmit the question(s) to the show in any manner so long as the show receives the questions.

Advancing to block 320, the user asks their specific question or questions. In one embodiment of the invention, the user presents the question to a production crew before the user asks the question live on the air. This allows the production crew to ensure that the question is relevant. Media is selected that is appropriate to answer the user's question, or to help aid in clarifying what the user is asking (block 330). At block 340, the selected media is assembled into a broadcast record associated with the caller. Decision block 350 determines if the user has any more questions. If so, the process returns to block 320 at which point the user can ask more questions. Otherwise, the production crew moves to the next caller (block 360). The logical flow ends when the show ends or enough callers are queued up to fill the remaining time in the show.

FIG. 4 displays a flow chart illustrating a call screening process. Generally, the call screener(s) take incoming phone calls and has the ability to view the callers queued, edit details of calls having a pending status, assemble records for callers by associating media with a caller, change a caller's status from Pending to Approved, from Inactive to Pending, and from Pending to Incomplete, change a caller's status from incomplete to Pending if, for instance, a caller is accidentally disconnected and calls back, preview selected images and text and edit records with a status of pending or inactive.

Referring to FIG. 4, call screeners accept questions from both e-mail and the telephone. The two systems are not interrelated; screeners can process e-mail and phone calls independent of each other. Both processes result in broadcast-ready content being sent to the producer once approved.

Starting at block 410, the call screener receives a call. At this point the caller is assigned a pending status automatically (block 420). Pending status is a flag indicating that the caller is in the process of being approved. Moving to block 430, the screener gathers information including caller information and the specific details of the question the producer uses to determine which questions are presented to the on-air talent. According to one embodiment of the invention, the screener records the caller's name, home city, line number (if applicable), problem title, and a brief synopsis of the caller's question. The synopsis includes the problem title, location, description, damage, frequency of occurrence, and caller comments. At block 430, the screener assembles related media from a searchable database and attaches the information to the caller record. Once the information has been assembled the screener marks the record's status as Approved (block 440). Once approved, the records are automatically sent to the producer (block 450).

The screener can also assign “incomplete” status to a call (block 460). If the status is incomplete, this usually means that the screener is unable to gather sufficient information about the call or that the call was terminated prematurely. Incomplete calls can be accessed at a later time to add information if necessary (block 470).

Screeners follow the same process for e-mail queries. E-mail may also be processed in advance of the live show as well as during the live show. Screeners can go through e-mail well in advance of the show to prepare content for the show. This provides additional content for the producer and on-air talent to use during the show. Referring to FIG. 4, the screener opens the e-mail (block 480) at which point the pending status is assigned automatically (block 490). As will be appreciated, queries may be received in other ways.

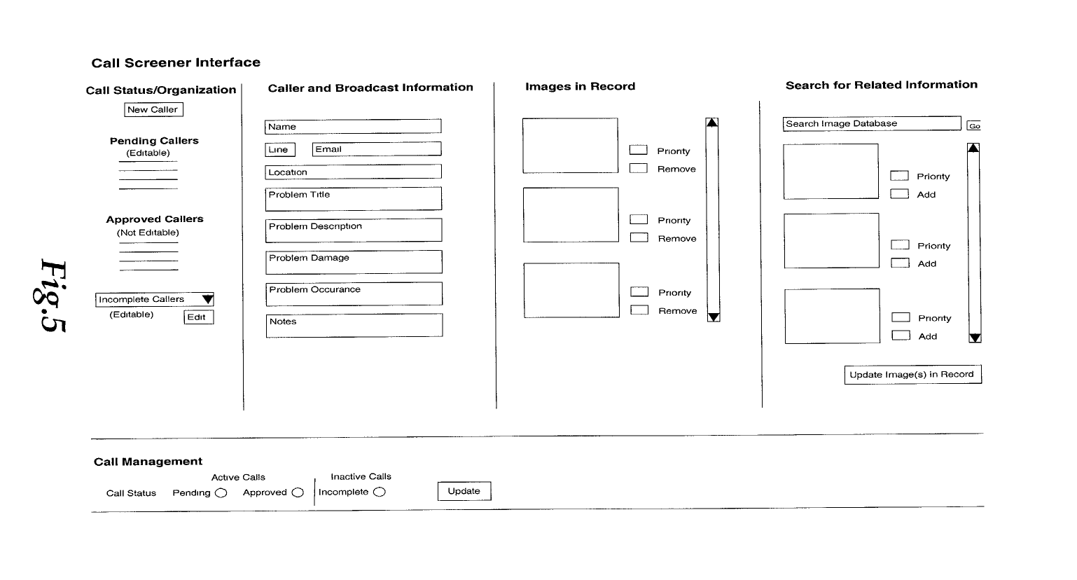

FIG. 5 is an exemplary screen diagram of a call screener interface according to one embodiment of the invention. The call screener interface allows a screener to easily view and edit caller information. From this interface, the screener may view and edit pending and incomplete callers, view approved callers, edit caller information, edit the images in the broadcast record, search for images within the media database, as well as update the caller status.

The production crew tracks callers and caller records by assigning each caller a status. The status is updated depending on where the caller is in the Web show process. Pending callers are in the screening process. Approved callers are on hold and are ready to go on the air. The Current caller is on the air. When the call is completed, the producer changes its status to Complete. If a caller is disconnected or hangs up, the record is marked as Incomplete until the caller calls back or the show ends. Table 1 shows the caller's status according to one embodiment of the invention.

TABLE 1
Caller Status

| Active | | | Inactive | |
|---|---|---|---|---|
| Pending | Approved | Current | Complete | Incomplete |
| Talking to | Approved by | Currently | Finished | Hung up, |
| screener | screener, | alking to host | talking to | disconnected, |
| | under review | | host | rejected, etc. |
| | by producer | | | |

FIG. 6 shows a flow chart of a producer process. Generally, the producer has technical control over the aspects of the show. This control includes determining which calls the host will answer as well as determining what media the host and users connected to the show receive. The producer tracks the conversation between the host and the current caller and to post broadcast updates at the appropriate time. The producer also has the ability to look ahead at callers in the Approved queue and prepare the records for the next caller. The producer may assemble and update caller records and post broadcast updates. Assembling updates adds URLs in the broadcast records to the audio stream as the host covers the specifics of the topic. Additionally, the producer may serve as a co-host of the show, or may run the show completely.

Starting at block 610, the producer views a list of pending, approved, current, and broadcast records. The producer may edit information associated with any of these callers. The producer may change a caller's status from Current to Complete, from Incomplete to Approved, from Approved to Pending, and from Complete to Approved. Statuses are automatically changed from Current to Complete after the call is completed and from Approved to Current when the call is the current caller on the show.

Moving to block 620, the producer opens an approved broadcast record. At block 630, the producer reviews a broadcast record associated with a particular caller. Decision block 640 determines if the broadcast record contains the desired media. If so, the broadcast record is broadcast to the users at block 680. If not, the producer may modify the content of the broadcast record. According to one embodiment of the present invention, once the producer has a completed broadcast record, the media is assembled to stream to the users over the network. The media is streamed based on Microsoft Windows Media technology and works with Windows Media Player Version 6 or newer. Similarly, the show's web site is designed to work with Netscape Navigator or Microsoft's Internet Explorer Version 4 or newer. The media, however, may be streamed using other streaming technology such as developed by Real Networks. The media does not need to be selected by an individual. For example, the media may be selected by the computer system automatically. For example, media packets can be selected based on keywords contained in the question asked by the user. For example, if the question contains “tomato” then the system can retrieve all pictures related to tomatoes and assemble the media to be streamed. The producer also has the ability to preview selected images and text as well as search for new media to add to the record.

The producer also has the ability to insert broadcast update URLs and pre-prepared commercial clips into the broadcast (block 625). The producer may also interrupt the broadcast at any point during the show (block 635). The producer may also end the show. Additionally, the producer may control the soundboard or an audio engineer may control the soundboard allowing the producer to concentrate on management of the Web show application.

The producer chooses which pieces of the broadcast record are displayed to the on-air talent. Once the producer has selected information, the content is updated and the URL is sent to the broadcast stream.

Decision block 670 determines it the caller needs additional information not contained within the last broadcast record. If not, the logical flow moves to block 690 at which point the status of the caller is automatically marked completed and disconnects the caller if they called the show using a telephone. If the caller does need additional information, then, at block 660 the producer may add, delete, or reorder content within the broadcast record. For example, if there are several possible answers to a caller's questions, the producer may prepare additional records by opening the original record and choosing different content provided by the screener. The producer also has the option of searching for additional content to add to the broadcast record. Once the broadcast record is in a format acceptable to the producer the content of the record is updated at block 650 and returns the logical flow to decision block 640 that determines whether the broadcast record is ready to broadcast.

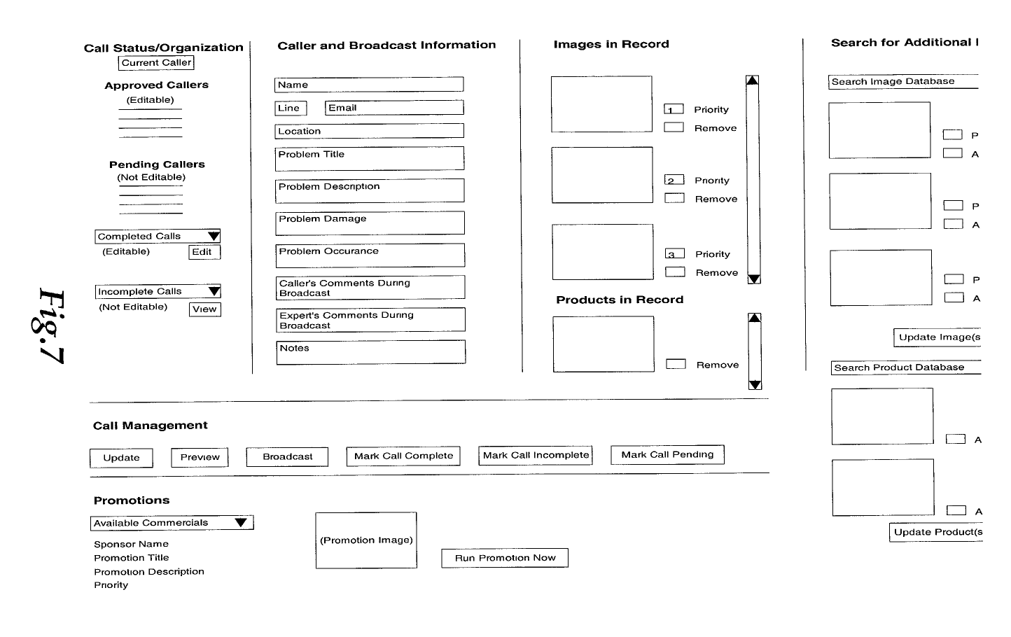

FIG. 7 is an exemplary screen diagram of a producer interface according to one embodiment of the invention. The producer interface allows the producer to easily control aspects of the show. From this interface, the producer may view and edit approved callers, view pending and incomplete callers, edit caller information, edit the images in the broadcast record, search for images within the media database, broadcast records, add promotions and products to the stream, as well as update the caller status.

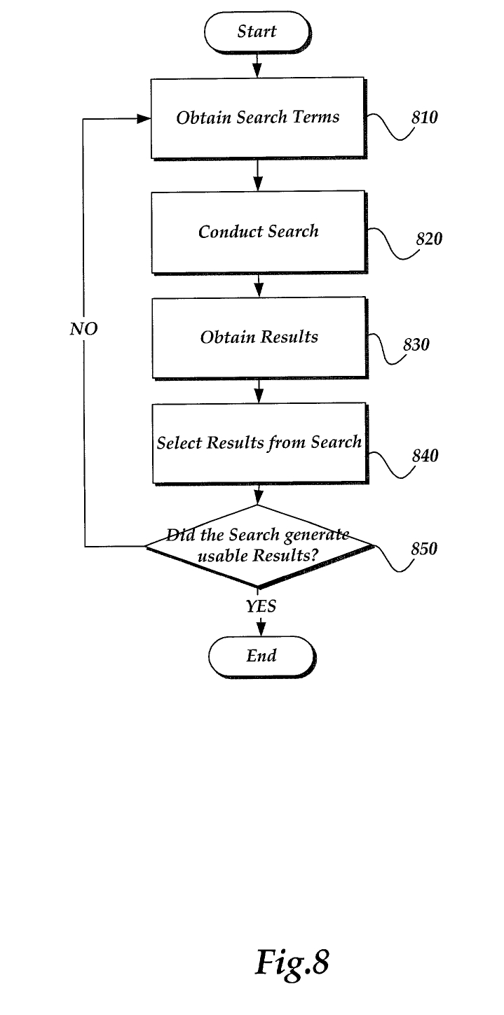

FIG. 8 is a flowchart illustrating searching for media to be included in a broadcast record. In response to a particular question, the production crew selects media from a database. In an embodiment of the present invention, the content is stored in a database, such as a Sequel Version 7.0 database developed by Microsoft Corporation that is accessed in real time. Many other database programs can be used. All that is required is that the media be capable of being sent during a show. Various media types can be assembled together to form a single “streaming” clip, may be maintained separately, or maintained in both formats. The streaming clip provides an efficient way to select rich content with not much effort during a broadcast.

Starting at block 810, search terms are obtained to search a database. Search terms may be generated many different ways. For example, the call screener, producer, and/or host may generate terms to search the database. Additionally, a natural language parser can provide the search terms from the question. As will be appreciated, the search may be run one or many times.

Advancing to block 820, once the search terms are generated a search is conducted in the database or databases containing the media. The database may be any repository containing media related to the show and the search may be in any format acceptable to the database search engine.

Moving to block 830, the results of the search are displayed to the searcher. From these results the searcher may select media to be included in the broadcast record (block 840). Decision block 850 determines if the search generated results that are included in the broadcast record. If not, the logical flow is returned to block 810 at which point the searcher may refine the search terms. If the results are acceptable the logical flow ends.

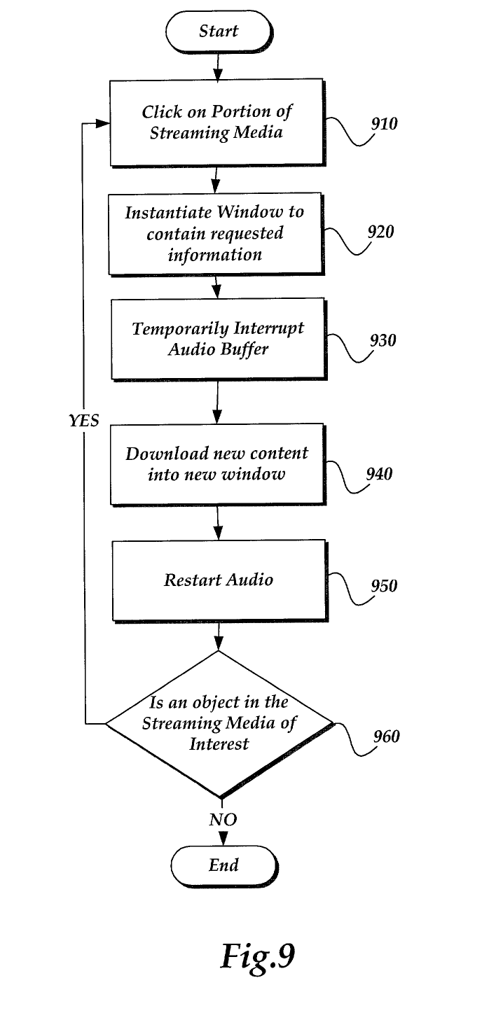

FIG. 9 is a flowchart illustrating a user selecting a portion of the interactive media they are viewing. If the user is interested in a portion of the media, the user may select the portion of the media they are interested in by clicking on a link embedded in the media (block 910). In other embodiments, the participant may select items of interest by voice recognition, keyboard activation, and the like.

Advancing to block 920, once an interactive portion of the media is selected, an additional window is instantiated to hold the requested information. For example, if a link selected by a user is about a particular fertilizer then the new window displayed contains information relating to the fertilizer. The user may learn relevant facts about the product being displayed, as well as learn where they may purchase the product in proximity to where they live.

Buffering of the media to the main display is temporarily interrupted to the main display window in order to load the requested media (block 930). The new downloaded content is then loaded into the new window (block 940). After the new content is loaded into the window, the shows buffer is restarted (block 950). Typically, the new content is loaded before the buffered media has been exhausted providing a seamless interaction for the client. If the buffered media has been exhausted the participant, could depending upon connectivity speed, not hear the show. As is well known, the amount of buffering may be modified to eliminate almost all dead time. For example, if there is dead time when only 10 seconds of media is buffered, then the media system can buffer the amount of media until there is typically no dead time. Decision block 960 determines if the user is interested in another portion of the streaming media. If so, the process returns to block 910 and the user can select another portion. Otherwise, the logical flow ends.

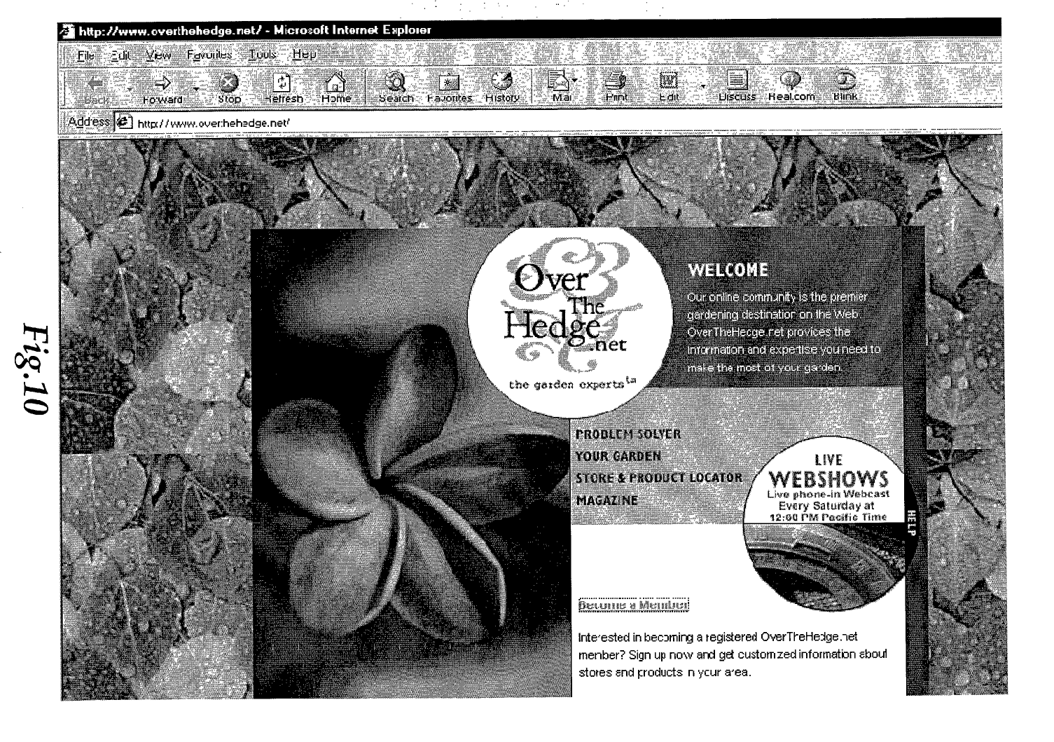

FIGS. 10-22 show exemplary screen diagrams according to one embodiment of the invention. According to the particular embodiment shown in FIGS. 10-22, a networked show on gardening is provided. The gardening show is conducted weekly, in which a host and a gardening expert hold an interactive gardening show much in the manner of a traditional radio show in gardening, but with the addition of interactive streaming media content. Users describe gardening problems to the show's production crew who then retrieve media from the database, assemble the media into a broadcast record, and stream the media to the users connected to the show. The media includes plant images, gardening products, plant data, products, commercials, and the like. The gathered information is compiled into a broadcast record that is sent to the users connected to the show when the caller is on the air. The broadcast stream typically provides viewers with the product information that will help solve the particular problem as well as information on where to purchase the products.

Users hear the discussion between the host and caller while seeing the selected images and information contained in the broadcast stream. The live shows are recorded and are available for review immediately after the live show has ended. The viewer may e-mail questions related to the show to the show for possible future answering, either during the next live show or at some other point. Listeners typically access the show on the WWW in which a Microsoft Windows Media Player is launched within the listener's browser window. An audio stream is buffered and then played to the listener's of the live show.

Based on Windows Media technologies, SQL database interactivity, and Active Server Pages (ASP), the live show consists of a low-bandwidth audio stream synchronized with URLs targeted to load in a specific frameset within the gardening site. Streaming media technology allows several types of data to be sent together, including audio, video, text, and scripted events. The live show uses audio with scripted events that instruct a Web browser to open a specific URL.

Each URL calls an ASP page that reads records from a SQL database. The record number determines which information from the gardening database to display. The Web show also includes pre-produced commercial segments.

The host and expert receive questions either through e-mail or call-in. The show may also receive questions many other ways. For example, the questions may come through mail, chat rooms, and the like. In one particular example, a question was “Why do my home-grown tomatoes have tough skins?” The host transfers this question to text and includes the question along with the appropriate visual representation that most appropriately matches the question. The host streams the pictures of various varieties of tomatoes along with the question located above the screen. The expert and host talk about various causes and problems that may cause the problem the caller is asking about. The host selects products that may help with the problem. In this particular example, the host selects products relating to fertilizers. The selection of fertilizers is streamed to the listeners at which point they may find out more information about the products by selecting the embedded links in the streaming media. For example, if they wanted to learn about Fertilizer A the listener selects the link, and another Web page is brought up containing more detail and allows the listener to enter information so that a store close to them may be located that sells the particular product. Typically, enough audio is buffered that the feed to the show is not interrupted while the new content is loaded into the new windows. While the user is looking at the information the host and expert continue speaking about the problem. The user is free to navigate through the screens as the host and expert continue their discussion or even move onto the next question. After the question(s) have been answered the host receives another question and the process repeats.

Referring to FIG. 10, an exemplary home page of the gardening site is displayed. The home page for the gardening site lists the days and times of live Webcasts as well as allows user to become a member of the site. If a live show is not currently being broadcast, site visitors can view the most current archived show. If a live show is being broadcast, they can view the current show and call in with their gardening questions.

Members are able to sign in from this page, but the site is open to all visitors whether they're members or not. The purpose of membership is to allow for regional ads, promotions, and newsletters that are provided. The benefit of membership also provides users with quick access to information on local retailers.

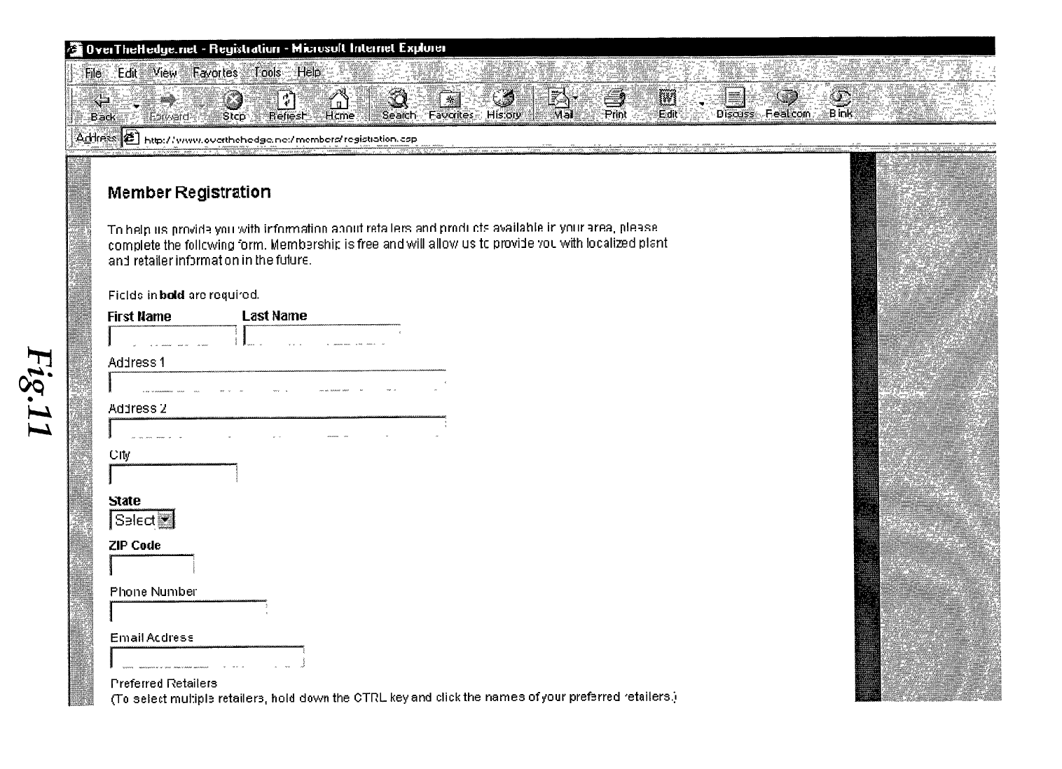

FIG. 11 displays an exemplary screen diagram for member registration. The user may obtain customized information during the Webcasts by providing name and address information. The user may also choose retailers that they prefer to use. According to one embodiment of the invention, the only required information for membership is first and last name, state and ZIP code. The user information may be used to customize content for the particular user.

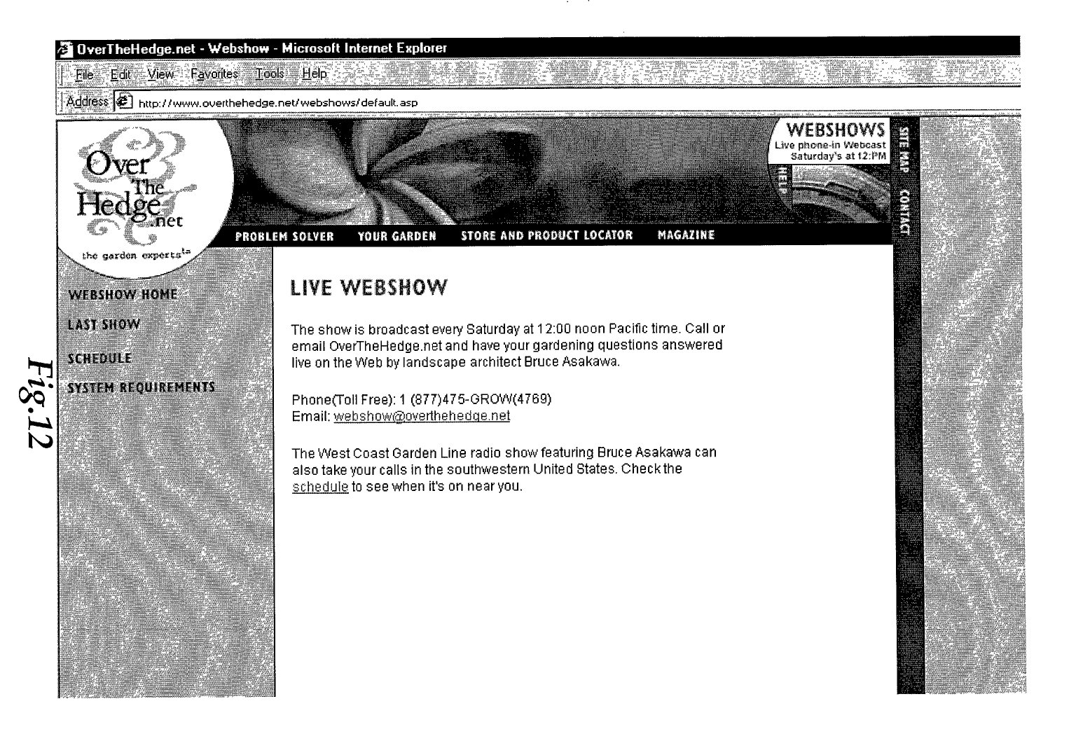

FIG. 12 displays an exemplary screen diagram of the live webshow page according to an embodiment of the invention. From this page, the user may access the live show, view the last show, and refer to the system requirements to view the show, as well as check the schedule of the live show. Additionally, a telephone number and e-mail address is shown which users may use to submit questions.

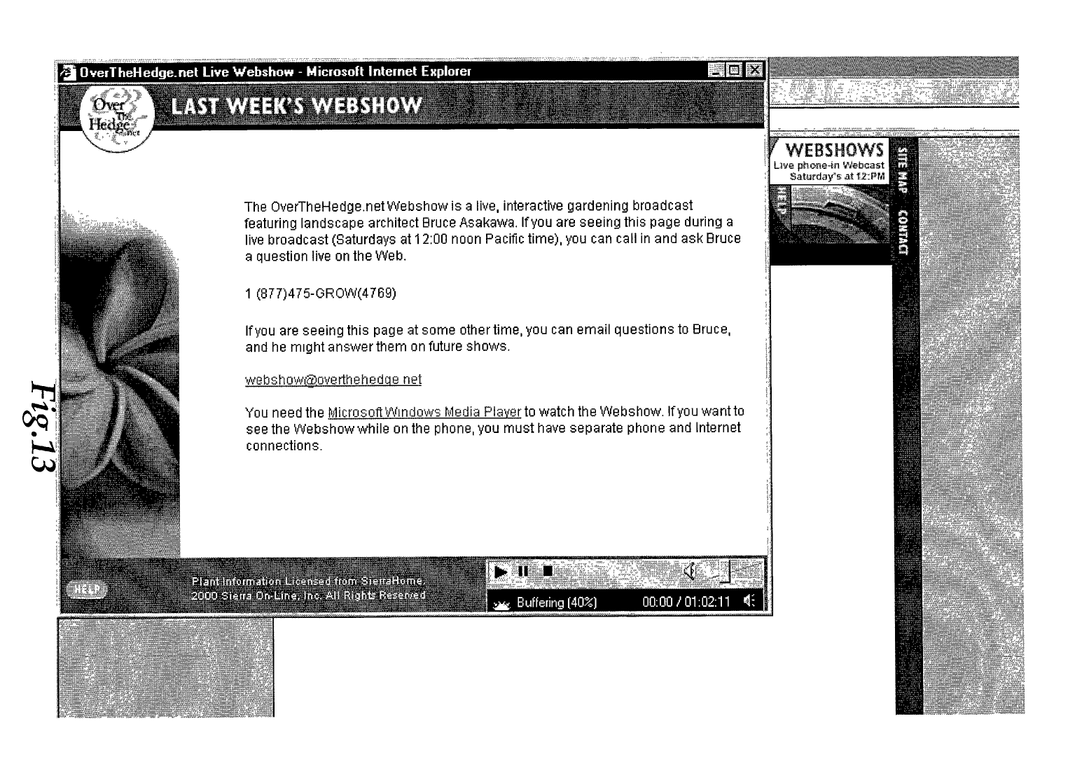

FIG. 13 is an exemplary screen diagram showing a Webcast window. In this particular example, the user is viewing an archived show. The functionality of the archived show and the live show are the same except for that there is no live interaction between the host and the user during the archived show. The user, however, may e-mail questions to the host that may be answered in future shows.

The Webcast page appears in a browser window separate from the rest of the gardening site. It has the look and feel of a stand-alone broadcast application. According to one particular embodiment of the invention, the Web show page for both the live show and archived show contain the following elements:

A dedicated control frame for the Windows Media Control and audio stream

A broadcast summary frame containing:

An overall short description of the broadcast (main focus, problems discussed)

Current caller's name and home city

Short description of current caller's problem

Expert's name

Short summary of caller/expert discussion

A problem image frame containing one or more images relating to the current caller's problem. Each image would have a brief description.

A product frame containing one or more product recommendations for the current caller's problem. Each product recommendation would have the following information:

A product image

A brief product description

A promotion frame containing (while a promotion audio clip is running in the control frame):

A promotional image

A title for the promotion

A brief description of the promotion

According to other embodiment, more or less information as described above is contained within the Webcast window.

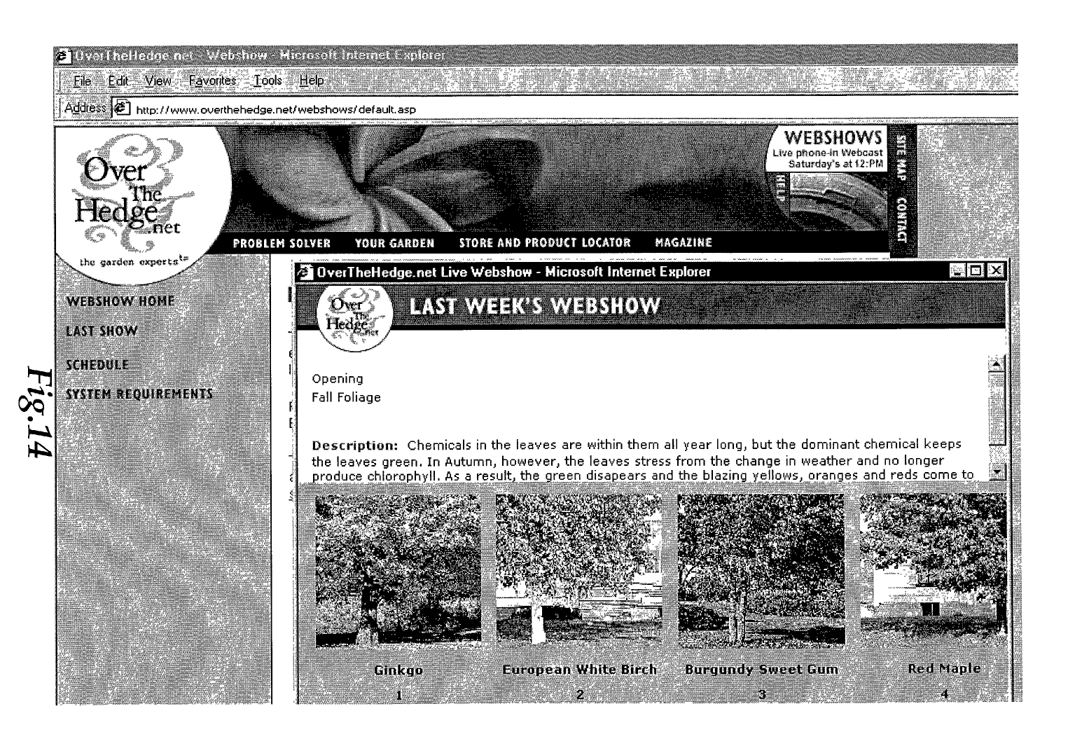

Referring to FIG. 14, an exemplary screen diagram of an opening of a gardening show is shown. As can be seen by referring to the window, the opening is discussing fall foliage. Located beneath the Opening is a description of why leaves change colors along with some pictures selected to enhance the host's oratory on the subject.

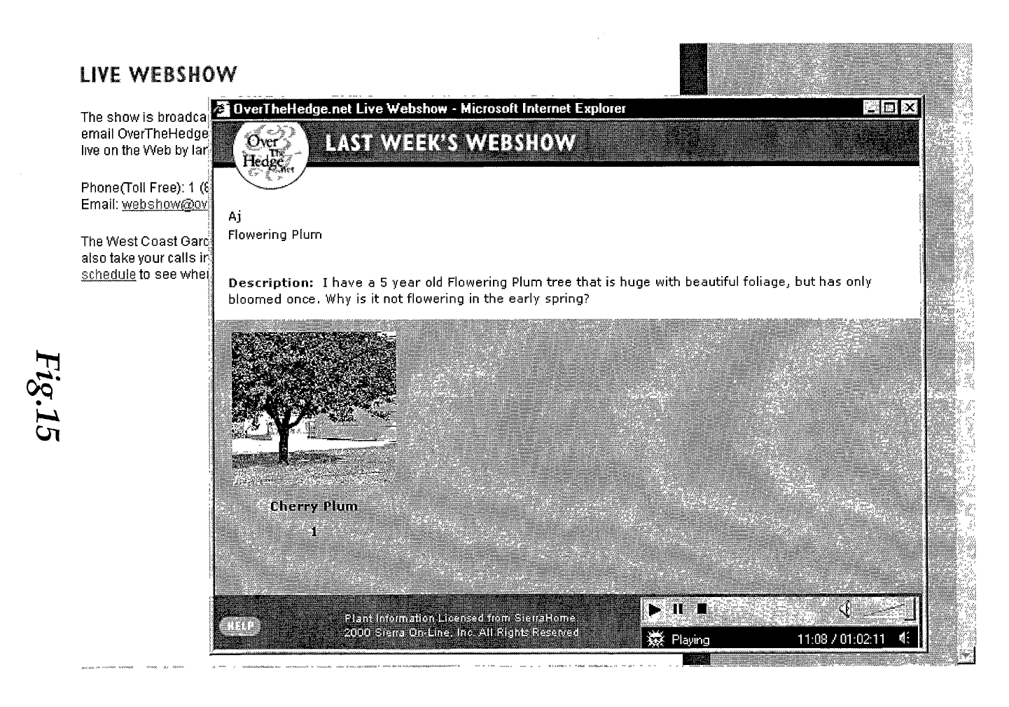

FIG. 15 is an exemplary screen diagram showing a question by a user who called in asking a question about a flowering plum. The show's production crew assembled a single picture showing a cherry plum to provide the users in the audience with an example of a flowering plum tree. The user can see what point of the show they are viewing. If the user connects to a live show the user joins the live show in progress. On this particular screen, the timing is at eleven minutes eight seconds into a show lasting one hour two minutes eleven seconds.

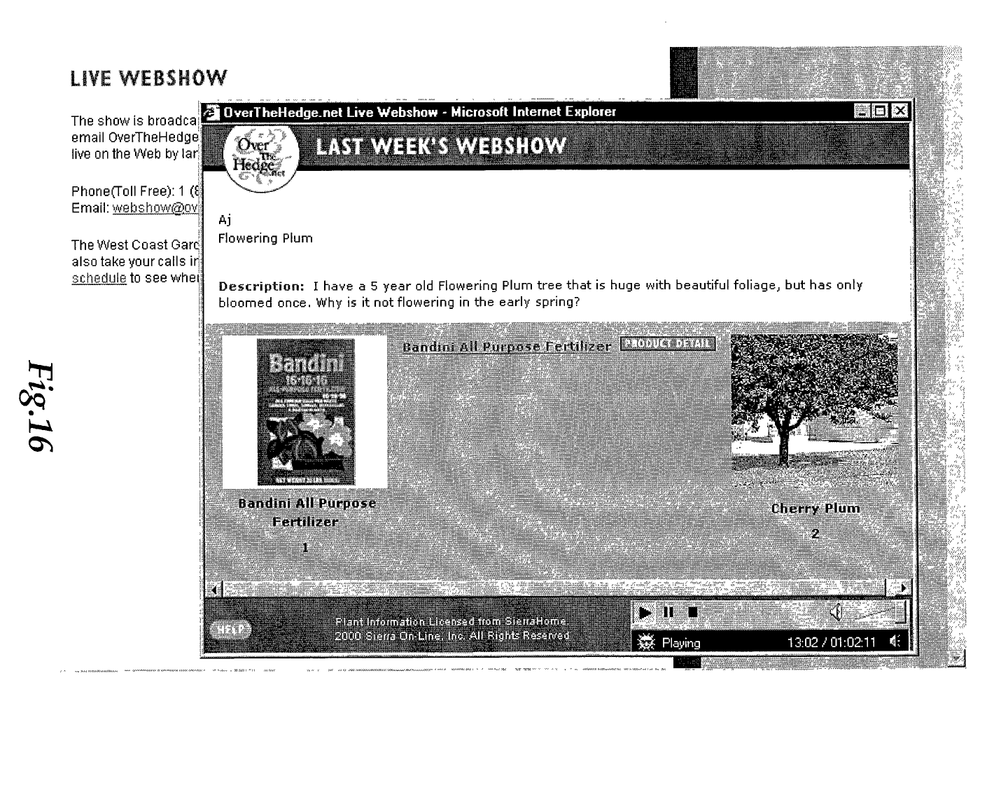

FIG. 16 is an exemplary screen diagram showing added media in the broadcast record during the call by the user. In addition to the picture of Cherry Plum 2, a picture and text of a fertilizer are displayed. The product is added to provide information for the users on how to help solve a particular problem. In this particular example, the fertilizer is selected to help enhance the flowering ability of the tree. As the hosts are talking with the user on air, the media is modified to contain the link. At this point, any user connected to the show may select either the picture or the textual link for the picture in order to obtain more information about product 1.

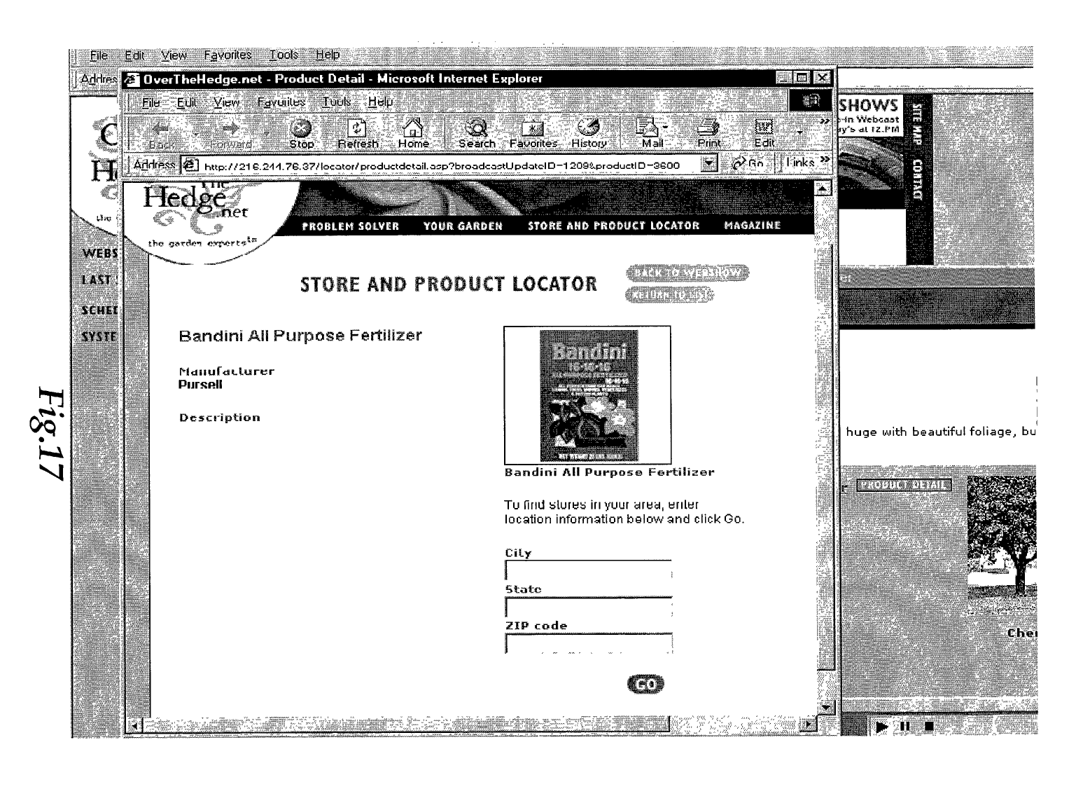

FIG. 17 is an exemplary screen diagram showing a product page. In this diagram, a user has selected the link contained within product 1. A new window is instantiated that contains more information about product 1. If the user would like information on how to purchase the product contained within the window they may fill out the input fields relating to city, state, and ZIP code.

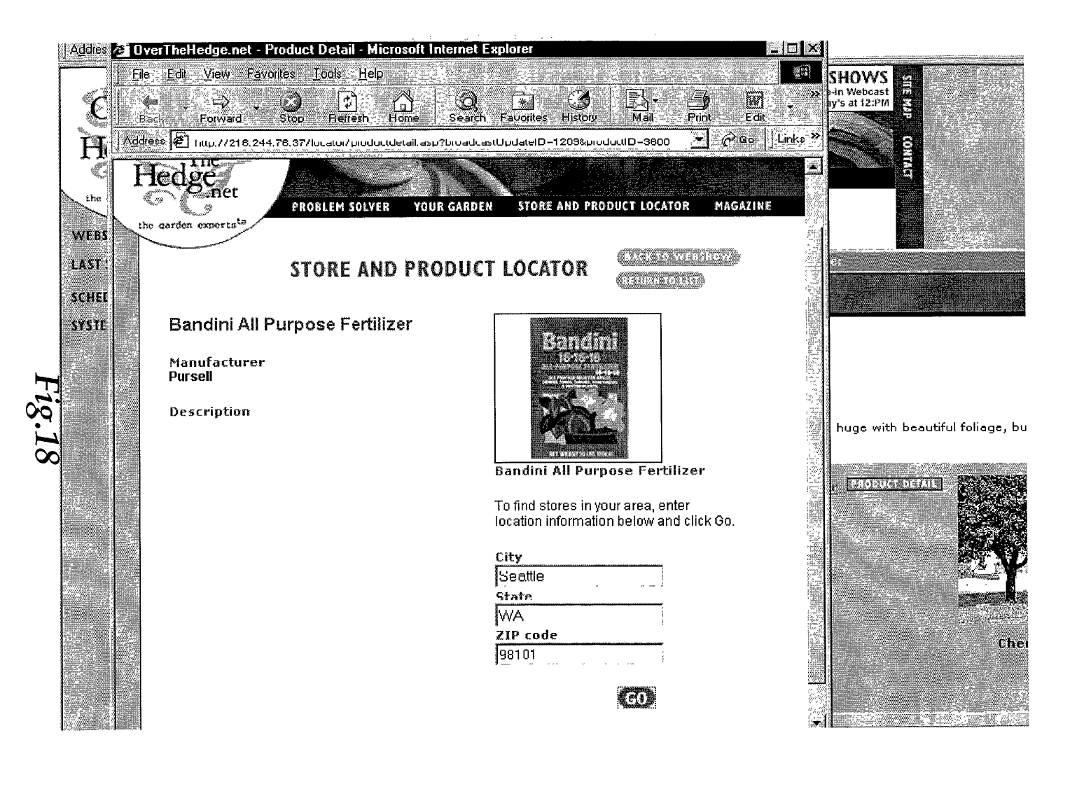

FIG. 18 displays an exemplary screen diagram of entering information into the input fields to obtain information on where to purchase a product. In this particular example, “Seattle” is typed into the city input field, “WA” is typed into the state input field, and “98101” is typed into the ZIP code input field. After entering the input field information, the user may hit return or the go button.

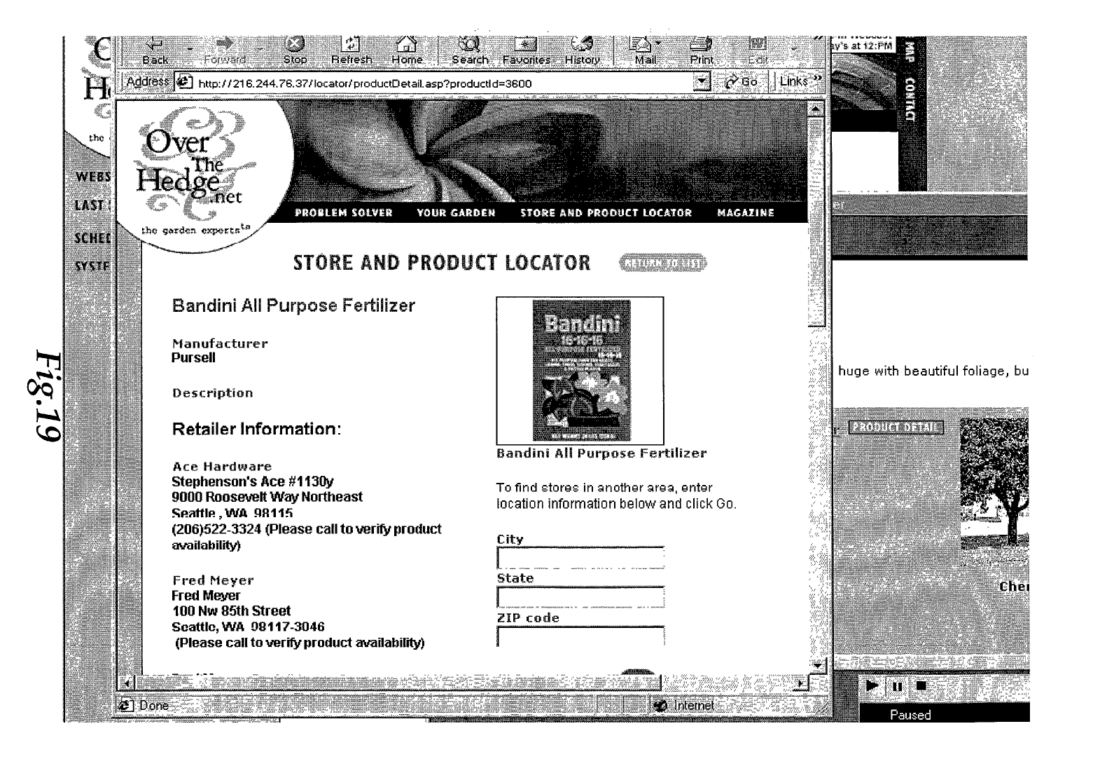

FIG. 19 displays an exemplary screen diagram showing where a product may be purchased. Several different retailers are displayed under the heading retailer information. Several more retailers are listed within the product window, but cannot be seen in this diagram without scrolling the window.

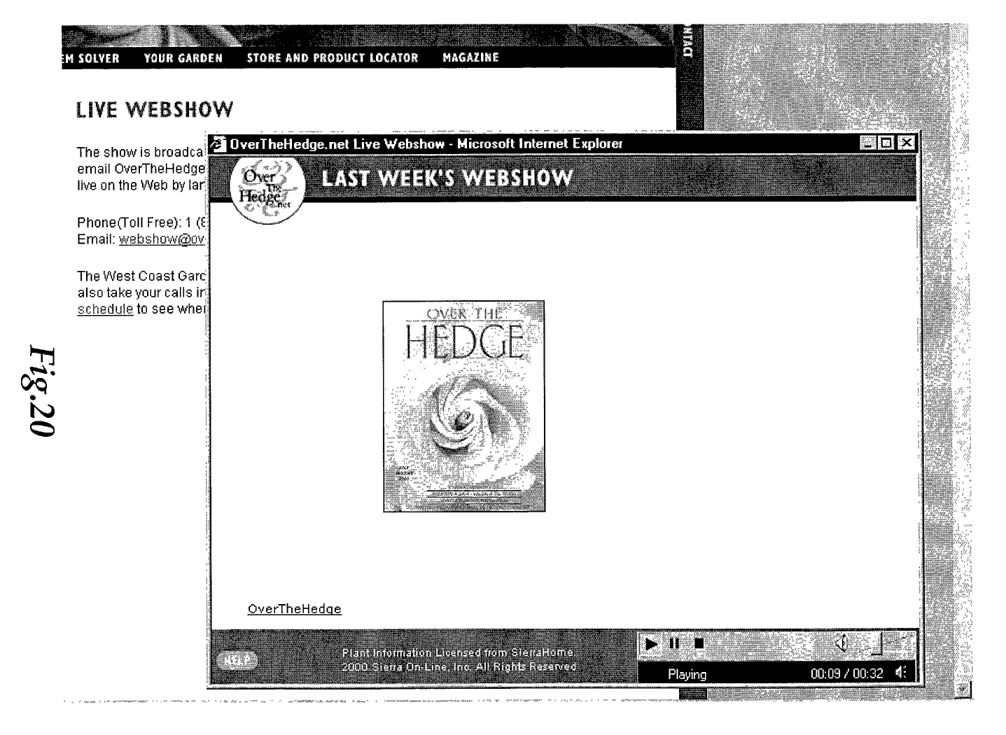

FIG. 20 displays an exemplary screen diagram of a commercial break during the show. Periodically throughout the show commercial breaks are taken that provide information and interactive links about the sponsors of the show. A picture related to the commercial is displayed that may also be selected in order to find out more information about the product or service being advertised.

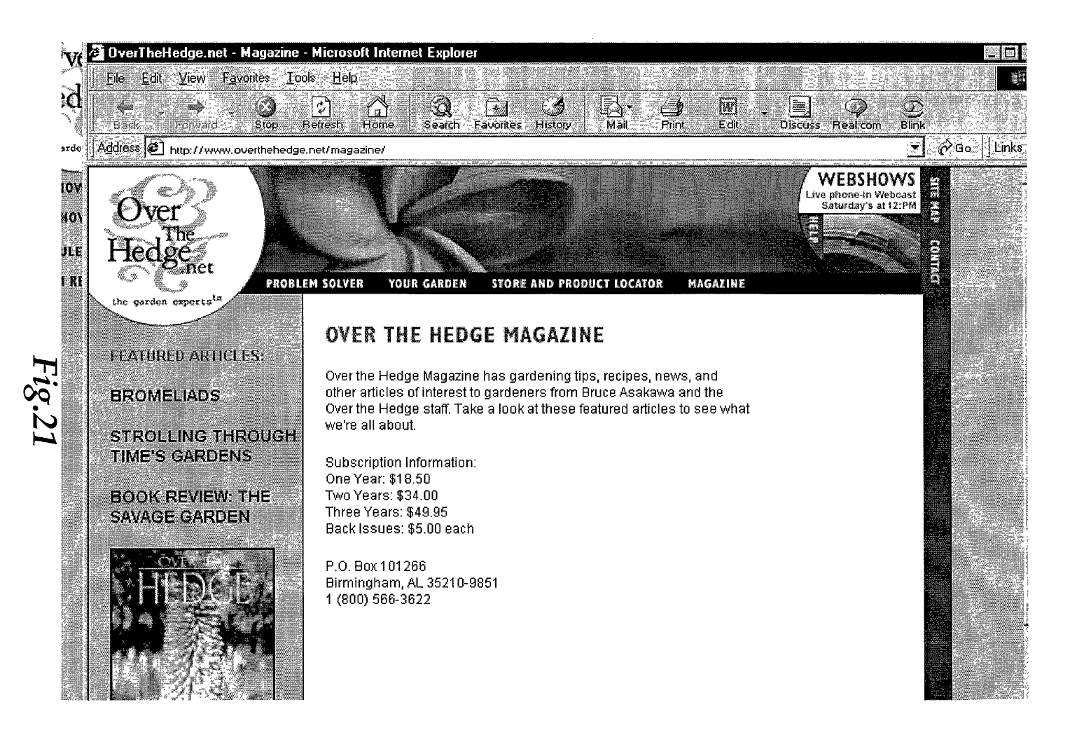

FIG. 21 displays an exemplary screen diagram after selecting the product within the commercial. In this particular example, information is provided about the Over the Hedge magazine being offered. The information includes how to obtain a subscription to the magazine being offered as well as price. Once the user is done viewing the information they may close the window at any time and return to the main Webcast window.

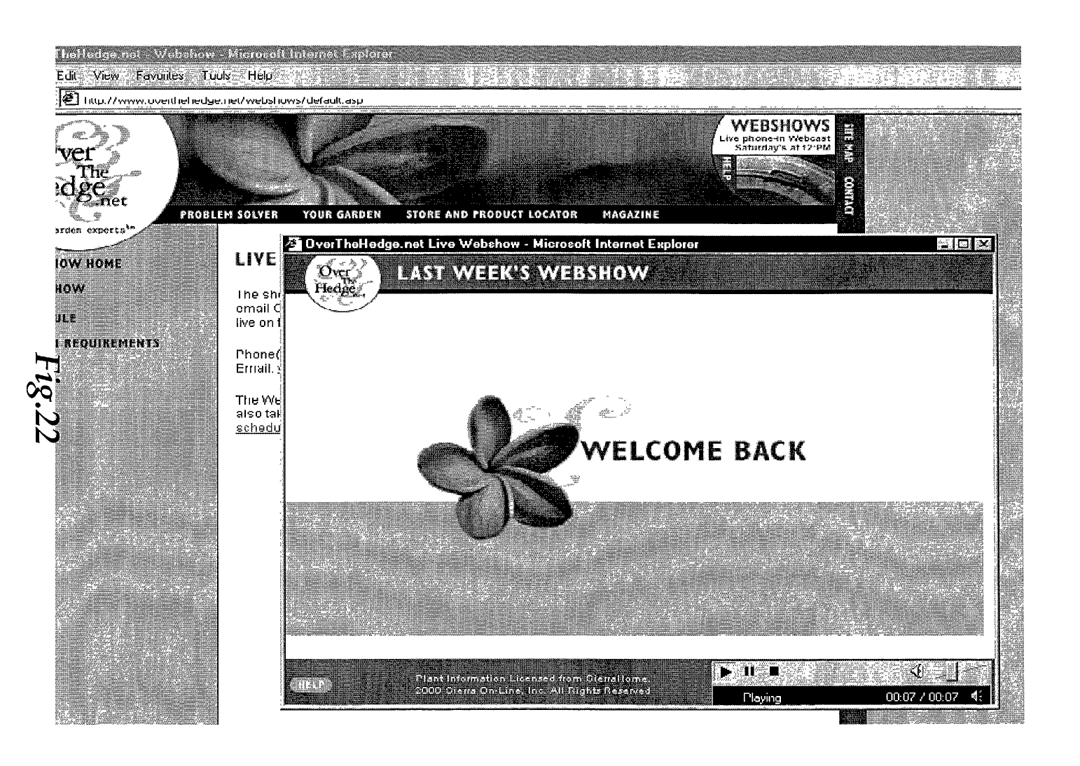

FIG. 22 displays an exemplary screen diagram showing returning to the Webcast after a commercial break. Once the commercials are finished the host feeds the live audio along with a welcome back screen to the users providing a seamless interactive experience.

While one particular example has been provided there are many other alternatives in which to practice the invention including radio stations, retailers, realtors, seminars, web directories, e-tailers, manufacturers and wholesalers, large entities with multiple locations often have difficulty communicating with all their employees, and the like.

Currently, many radio stations simulcast their studio format. According to one embodiment of the invention, radio stations can provide interactive content by providing interactive visuals and generating an additional revenue source—the visual, interactive commercial.

The radio station can attract listeners to the Web by combining their radio simulcast with live interactive media to deliver real-time interaction. The radio show now includes audio/visual streaming, and visual interactive commercials. Advertisers (especially those associated with talk radio), now have the ability to the ability to track exactly who listens to the Webcast and when providing them with targeted demographics.

Under the traditional product showcase model, there are often too many locations or it is too costly for the expert/demonstration to visit each store site. Additionally, each location may not have enough floor space to effectively showcase products.

Any retailer that has a Web site now can showcase products and stream commercials. Clothing retailers can have “fashion events.” Home furnishing retailers can display the same product in multiple scenarios. All locations may interact and conduct one live demonstration. The show is broadcast directly to multiple stores, where each customer may pick up the phone and call the expert. Customers may also view the demonstration and interact with the expert from their home computers. Shows can then be archived on a server for future viewing.

Currently, many realtors use print medium and paid TV programming to showcase real estate available for sale. Additionally, many have Web sites attempting to provide potential buyers information on each real estate property, utilizing written text and a still picture. According to an embodiment of the present invention, realtors can market multiple properties efficiently. A daily program showing today's activity—new listings, today's sales and new agents may be provided. The program streams audio and video and the host interacts with the visitors.

Conversely, a show can be tailored to just one buyer. An agent can prescreen properties based upon predetermined criteria and set up a program. Then, together, agent and buyer can take a virtual tour of the properties.

Coaches and motivational speakers can utilize smart streaming for instruction and team building. No longer does everyone need to come to a central location. Nor do the broadcasts require significant advanced planning just to do the broadcast.

Web directories need help to stand out in a sea of mediocrity. By adding interactive media to each directory entry, the directory visitor will be entertained and more likely to return to the site. In addition to, or instead of banners ad, the directory operator sells “real” advertising, helping to increase revenue and approach traditional advertisers.

The e-tailer, who displays and offers to sell products only through his Web site, finds that he wants to show more than just a still picture. According to an embodiment of the invention, an e-tailer may make the products it offers come alive with interactive entertainment, information and real-time content that inspires action. Visitors, who now spend more time on the site, are more likely to make a purchase. Shopping and entertainment become one.

Manufacturers and wholesalers have the ability to interact and inform their customers in real time about their products and services. This ability reduces time to market for new products and can reduce the cost of introducing new products. It also increases the efficiency in educating customers on new developments in their industry.

Large entities with multiple locations often have difficulty communicating with all their employees. According to an embodiment of the invention, employees “tune in” to live interactive broadcasts on earnings releases, changes to benefits or product updates through their Internet connections.

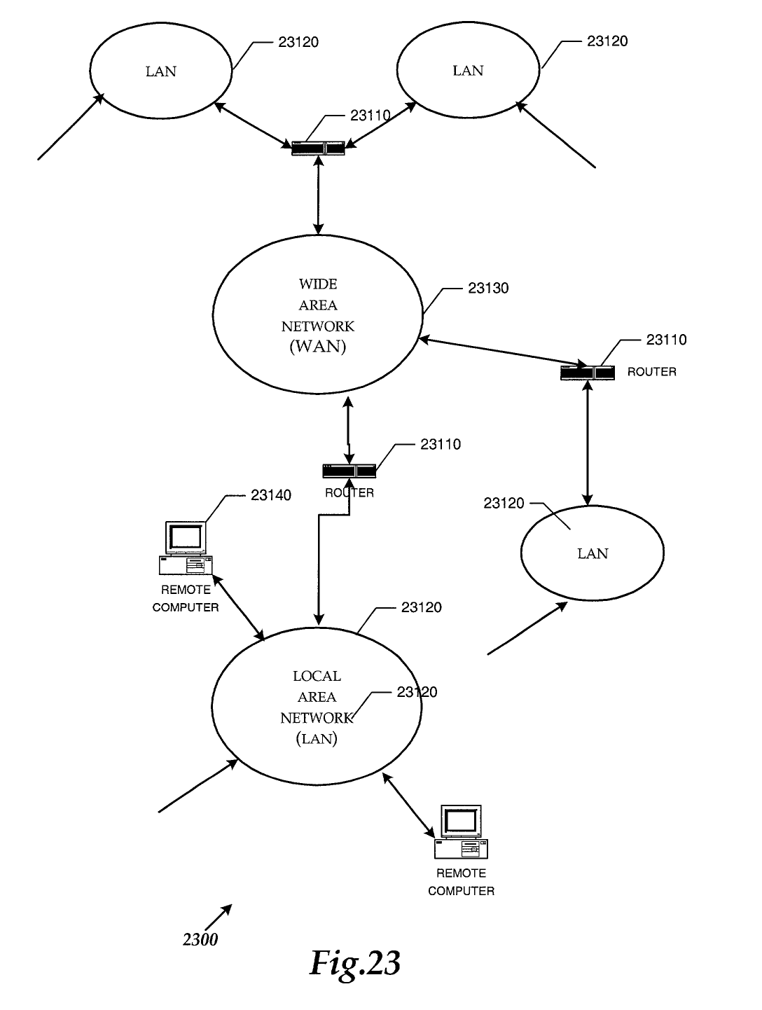

FIGS. 23-25 illustrate exemplary hardware environments for practicing the invention. As described above, aspects of the present invention are embodied in a WWW site accessible via the Internet. Generally, the term “Internet” refers the worldwide collection of networks and gateways that use the Transmission Control Protocol/Internet Protocol (“TCP/IP”) suite of protocols to communicate with one another. At the heart of the Internet is a backbone of high-speed data communication lines between major nodes or host computers, consisting of thousands of commercial, government, educational, and other computer systems, that route data and messages. A representative section of the Internet 2300 is shown in FIG. 23. FIG. 23 shows a plurality of local area networks (“LANs”) 23120 and a wide area network (“WAN”) 23130 interconnected by routers 23110. Routers 23110 are intermediary devices on a communications network that expedite message delivery. On a single network linking many computers through a mesh of possible connections, a router receives transmitted messages and forwards them to their correct destinations over available routes. On an interconnected set of LANs—including those based on differing architectures and protocols—using the same communications protocols, a router acts as a link between LANs, enabling messages to be sent from one to another. Communication links within the LANs are typically twisted wire pair, or coaxial cable, while communication links between networks may utilize 56 Kbps analog telephone lines, 1 Mbps digital T-1 lines, 45 Mbps T-3 lines, wireless links, or other communications links known to those skilled in the art. Furthermore, computers, such as remote computer 23140, and other related electronic devices can be remotely connected to either the LANs 23120 or the WAN 23130 via a modem and temporary telephone link. It will be appreciated that the Internet 2300 comprises a vast number of such interconnected networks, computers, and routers and that only a small, representative section of the Internet 2300 is shown in FIG. 23.

The Internet has recently seen explosive growth by virtue of its ability to link computers located throughout the world. As the Internet has grown, so has the WWW. Generally, the WWW is the total set of interlinked hypertext documents residing on HTTP servers all around the world. Documents on the World Wide Web, called pages or Web pages, are typically written in HTML (Hypertext Markup Language) or some other markup language, identified by URLs (Uniform Resource Locators) that specify the particular machine and pathname by which a file can be accessed, and transmitted from server to end user under HTTP (Hypertext Transfer Protocol). Codes, called tags, embedded in an HTML document associate particular words and images in the document with URLs so that a user can access another file, which may literally be halfway around the world, at the press of a key or the click of a mouse. These files may contain text (in a variety of fonts and styles), graphics images, movie files, and sounds as well as Java applets, ActiveX controls, or other embedded software programs that execute when the user activates them. A user visiting a Web page also may be able to download files from an FTP site and send messages to other users via e-mail by using links on the Web page. A WWW site is a server computer connected to the Internet having mass storage facilities for storing hypertext documents and running administrative software for handling requests for the stored hypertext documents. A hypertext document normally includes a number of hyperlinks, i.e., highlighted portions of text which link the document to another hypertext document possibly stored at a WWW site elsewhere on the Internet. Each hyperlink is associated with a Uniform Resource Locator (“URL”) that provides the exact location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, such as application programs written in the JAVA® programming language from Sun Microsystems, for execution on a remote computer. Likewise, a WWW server may also include facilities for executing scripts and other application programs on the WWW server itself.

A user may retrieve hypertext documents from the WWW via a WWW browser application program. A WWW browser, such as Netscape's NAVIGATOR® or Microsoft's INTERNET EXPLORER®, is a software application program for providing a graphical user interface to the WWW. Upon request from the user via the WWW browser, the WWW browser accesses and retrieves the desired hypertext document from the appropriate WWW server using the URL for the document and a protocol known as HTTP. HTTP is a higher-level protocol then TCP/IP and is designed specifically for the requirements of the WWW. HTTP is a protocol used to carry requests from a browser to a Web server and to transport pages from Web servers back to the requesting browser or client. The WWW browser may also retrieve application programs from the WWW server, such as JAVA applets, for execution on the client computer.

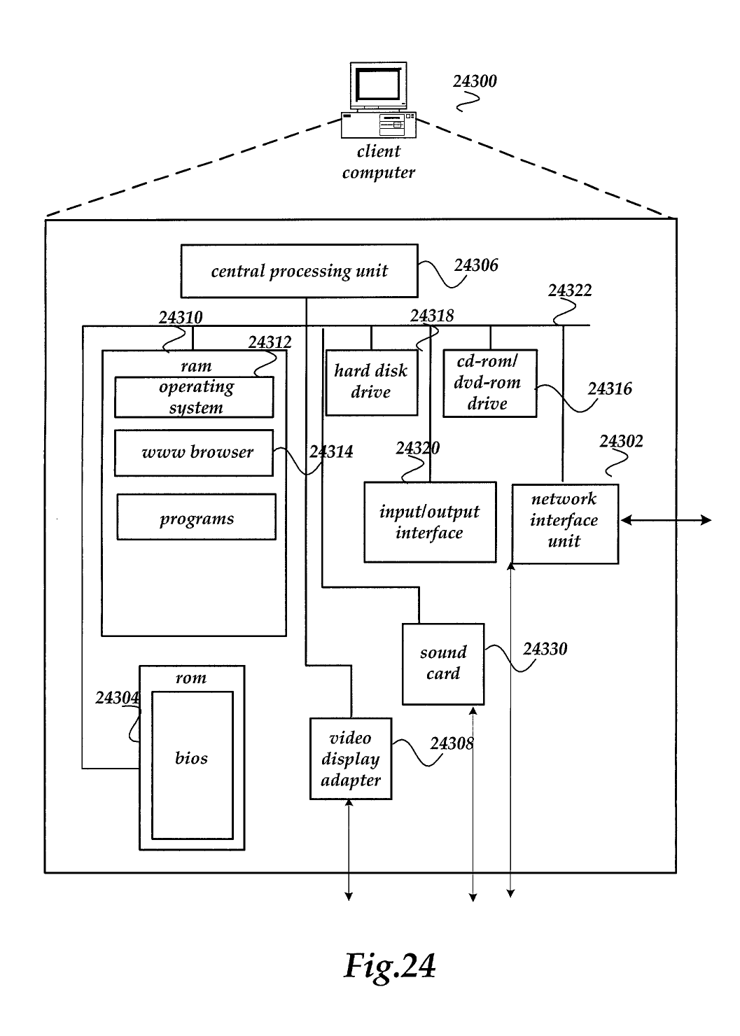

Referring now to FIG. 24, an actual embodiment of the present invention will be described. An audience participant may utilize client computer 24300 to connect to the Internet 2300 through a modem or other type of connection, such as a digital subscriber line (DSL), cable modem, or wireless connection. Once connected to the Internet 2300, client computer 24300 may utilize a WWW browser application program to view and interact with WWW sites such as a WWW site provided by WWW server 25200. As is known to those skilled in the art, client computer 24300 may comprise a general purpose personal computer capable of executing a WWW browser application program. Client computer 24300 may also comprise another type of computing device such as a palm-top computer, a cell phone, personal digital assistant, or the like.

Those of ordinary skill in the art will appreciate that the client computer 24300 includes many more components then those shown in FIG. 24. However, it is not necessary that all of these generally conventional components be shown in order to disclose an illustrative embodiment for practicing the present invention. As shown in FIG. 24, the client computer 24300 includes a network interface unit 24302 for connecting to a LAN or WAN, or for connecting remotely to a LAN or WAN. Those of ordinary skill in the art will appreciate that the network interface unit 24302 includes the necessary circuitry for such a connection, and is also constructed for use with the TCP/IP protocol, the particular network configuration of the LAN or WAN it is connecting to, and a particular type of coupling medium. The client computer 24300 may also be equipped with a network interface unit 24302 capable of connecting to the Internet through a point to point protocol (“PPP”) connection or a SLIP connection as known to those skilled in the art.

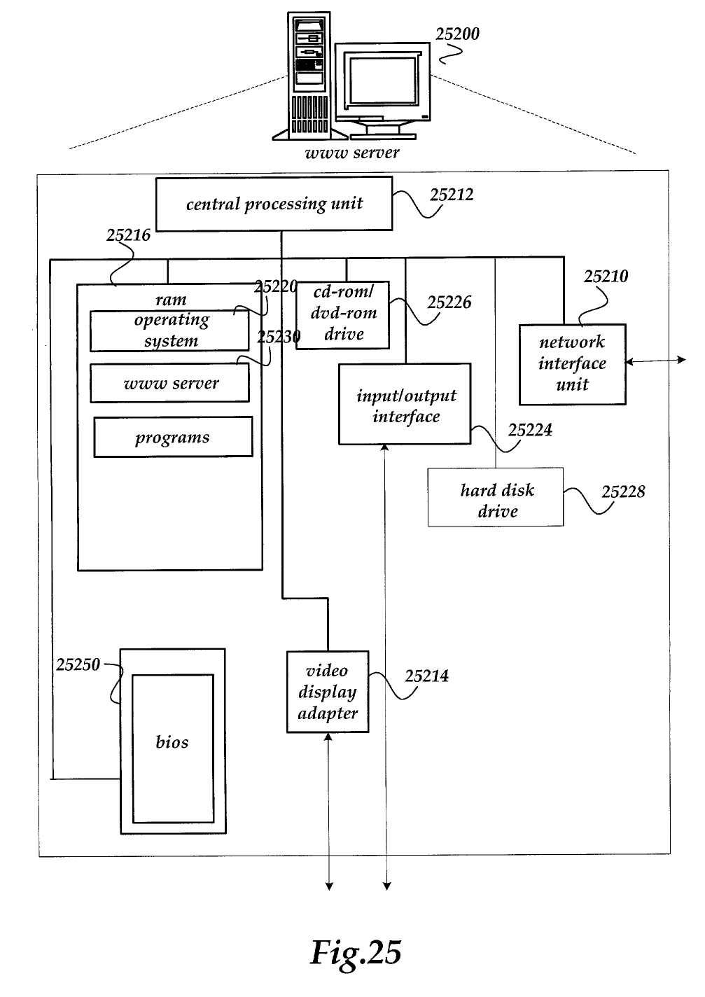

The client computer 24300 also includes a ROM BIOS 24304, central processing unit 24306, a video display adapter 24308, and a memory. The memory generally comprises a random access memory (“RAM”), a read-only memory (“ROM”) and some form of computer readable media. For example, computer readable media may be volatile and nonvolatile, removable and non-removable media implemented in any method or technology for storage of information such as computer readable instructions, data structures, program modules and other data. The memory stores an operating system for controlling the operation of the client computer 24300. The memory also includes a WWW browser 24314, such as Netscape's NAVIGATOR® or Microsoft's INTERNET EXPLORER® browsers, for accessing the WWW. It will be appreciated that these components may be stored on a computer-readable medium and loaded into memory of the client computer 24300 using a drive mechanism associated with the computer-readable medium, such as a floppy drive (not shown), CD-ROM/DVD-ROM drive 24316, or hard drive 24318. A graphic image may also be stored on hard drive 24318 for transmission to WWW server 25200 (FIG. 25). An input/output interface 24320 may also be provided for receiving input from a mouse, keyboard, or other input device. The memory, network interface unit 24302, video display adapter 24308, and input/output interface 24320 are all connected to the central processing unit 24306 via bus 24322. Other peripherals may also be connected to the central processing unit 24306 in a similar manner.

WWW browser 24314 may utilize a JAVA virtual machine to execute JAVA “applets” as known to those skilled in the art. In particular, a user may send a graphic image to the show to help clarify a particular question. An external viewer/proofing application, such as ACROBAT® from ADOBE CORPORATION, may also be used to proof the graphic image prior to transmission to WWW server. Additionally, a shopping cart applet may be utilized to allow the consumer to add merchandise to a “shopping cart” as they shop, and then to “check out” when their shopping is completed. Shipping and shopping cart applets are well known to those skilled in the

FIG. 25 depicts several of key components of a WWW server 25200. According to an embodiment of the present invention, WWW server 25200 is operative to provide a WWW site for providing interactive gardening and landscaping advice. Accordingly, WWW server 25200 transmits WWW pages to the WWW browser application program executing on client computer 24300 to carry out this process. For instance, WWW server 25200 may transmit pages and forms for receiving information about user, such as their address, telephone number, billing information, credit card number, etc. Moreover, WWW server 25200 may transmit WWW pages to client computer 24300 that allow the user to learn about gardening, plant diseases, and view and participate in Webcasts. These transactions may take place over the Internet 2300 or some other communications network known to those skilled in the art.

Those of ordinary skill in the art will appreciate that the WWW server 25200 includes many more components then those shown in FIG. 25. However, it is not necessary that all of these generally conventional components be shown in order to disclose an illustrative embodiment for practicing the present invention. As shown in FIG. 25, the WWW server 25200 is connected to the Internet 2300, or other communications network, via a network interface unit 25210. Those of ordinary skill in the art will appreciate that the network interface unit 25210 includes the necessary circuitry for connecting the WWW server 25200 to the Internet 2300, and is constructed for use with the TCP/IP protocol. Typically, the network interface unit 25210 is a card contained within the WWW server 25200.

The WWW server 25200 also includes a processing unit 25212, a video display adapter 25214, and a mass memory, all connected via bus 25236. The mass memory generally comprises a RAM, ROM, and a permanent mass storage device, such as a hard disk drive, tape drive, optical drive, floppy disk drive, or combination thereof. The mass memory stores an operating system 25220 for controlling the operation of the WWW server 25200. WWW server 25200 also has some form of computer readable media. For example, computer readable media may be volatile and nonvolatile, removable and non-removable media implemented in any method or technology for storage of information such as computer readable instructions, data structures, program modules and other data. WWW server 25200 may also have communication media (not shown) that embodies computer readable instructions, data structures, or other data in a modulated data signal such as a carrier wave or other transport mechanism and includes any information delivery media. A modulated data signal is a signal that encodes information in a signal. For example, communication media includes wired/wireless networks, acoustic, RF, infrared and other wireless media. It will be appreciated that this component may comprise a general purpose server operating system as is known to those of ordinary skill in the art, such as UNIX, LINX®, or Microsoft WINDOWS NT®. A binary input/output system (“BIOS”) 25220 is also provided for controlling the low-level operation of WWW server 25200.

The mass memory also stores the program code and data for providing a WWW site for providing show information. More specifically, the mass memory stores a WWW server application program 25230 as known to those skilled in the art. The WWW server application program 25230 comprises computer executable instructions which, when executed by the WWW server computer 25200, generate the WWW browser displays shown in FIGS. 10-22, including performing the logic described with respect to the above described FIGURES. The WWW server 25200 may include a JAVA virtual machine, a SMTP handler application for transmitting and receiving e-mail, a HTTP handler application for receiving and handing HTTP requests, JAVA applets for transmission to a WWW browser executing on a client computer, and an HTTPS handler application for handling secure connections. The HTTPS handler application may initiate communication with an external security application, or a credit card processing application for communicating with remote financial institutions in a secure fashion.

WWW server 25200 also comprises an input/output interface 25224 for communicating with external devices, such as a mouse, keyboard, scanner, or other input devices not shown in FIG. 25. Likewise, WWW server 25200 may further comprise additional mass storage facilities such as CD-ROM/DVD-ROM drive 25226 and hard disk drive 25228. According to an embodiment of the present invention, hard disk drive 25228 is utilized by WWW server application program 25200 to store several databases. In particular, the following databases may be stored and utilized by WWW server application program 25230: customer database, product database, image database, relationship database, and accounting database. Customer database may be utilized to store customer data, including account information such as customer name, address, user identification number, password, order history, credit card information, etc. Product database may be utilized to store information regarding the available products, inventory levels, etc. Image database may be utilized to store graphic images transmitted to the users. Relationship database may be utilized to store information regarding relationships with other retailers and/or partners. Accounting database may be utilized to store information regarding the number of units sold, accounts receivable and payable, and other accounting information. The operation and implementation of these databases is well known to those skilled in the art.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for providing a show over a network, comprising:
(a) receiving a question related to the show;
(b) in response to the received question creating a broadcast record that includes different forms of media;
(c) broadcasting the broadcast record over the network; and
(d) enabling interaction with the broadcast record and the show.

2. The method of claim 1, wherein receiving the question related to the interactive show, further comprises:
(a) screening the received question; and
(b) determining when the received question is related to the show.

3. The method of claim 2, wherein creating the broadcast record in response to the received question further comprises:
(a) searching for media related to the received question;
(b) receiving a result from the search; and
(c) assembling the broadcast record from the result.

4. The method of claim 3, wherein searching for media related to the received question, further comprises:
(a) generating a search term related to the received question; and
(b) searching a database with the generated search term.

5. The method of claim 4, wherein enabling the interaction with the broadcast record further comprises inserting at least one link into the broadcast record for information that relates to the show.

6. The method of claim 3, wherein creating the broadcast record is performed automatically.

7. The method of claim 1, further comprising:
(a) archiving the broadcast record; and
(b) providing access to the archived broadcast record.

8. The method of claim 1, further comprising:
(a) inserting a commercial segment into the broadcast record;
(b) obtaining a set of user information; and
(c) customizing the broadcast record with the obtained set of user information.

9. The method of claim 8, wherein inserting the commercial segment into the broadcast record further comprises targeting an audience for the commercial segment by using the obtained set of user information.

10. A computer-readable medium for broadcasting a show over a network having different forms of media to a user; comprising:
(a) connecting the user to the show;
(b) generating an interactive broadcast record related to a topic on the interactive show;
(c) broadcasting the generated broadcast record; and
(d) enabling interaction with the broadcast record without leaving the show.

11. The computer-readable medium of claim 10, wherein generating the interactive broadcast record further comprises;
(a) receiving at least one question related to the topic;
(b) obtaining a list of media related to the received question; and
(c) selecting from the list a set of media to include within the interactive broadcast record; and
(d) including the selected list of media in the interactive broadcast record.

12. The computer-readable medium of claim 10, wherein generating the interactive broadcast record further comprises inserting an advertisement into the broadcast record.

13. The computer-readable medium of claim 12, wherein inserting the advertisement into the broadcast record further comprises:
(a) obtaining a set of information from the user; and
(b) customizing the advertisement based on the obtained set of information.

14. A system for providing a show over a network, comprising:
(a) a processor and a computer-readable medium;
(b) an operating environment stored on the computer-readable medium and executing on the processor;
(c) a network connection device operating under the control of the operating environment; and
(d) a network server device operating under the control of the operating environment utilizing the network connection device and operative to perform actions, including:
(1) connecting a user to the show;
(2) receiving at least one question;
(3) generating a broadcast record related to a topic on the show;
(4) broadcasting the generated broadcast record to the user; and
(5) enabling interaction with the broadcast record and the show without leaving the show.

15. The system of claim 14, wherein receiving the at least one question, further comprises:
(a) screening the received question; and
(b) determining if the received question is related to the interactive show.

16. The system of claim 14, wherein generating the broadcast record, further comprises:
(a) searching for at least one media related to the received question;
(b) receiving a result from the search; and
(c) assembling the broadcast record from the result.

17. The system of claim 16, wherein searching for the at least one media related to the received question, further comprises:
(a) generating at least one search term related to the received question; and
(b) searching a database with the at least one generated search term.

18. The system of claim 17, further comprising an archiving device for archiving the broadcast record.

19. The system of claim 17, wherein generating the broadcast record further comprises inserting an advertisement into the broadcast record.

20. The system of claim 19, wherein inserting the advertisement, further comprises targeting the advertisement.

21. A modulated data signal having computer executable instructions embodied thereon for broadcasting a show over a network, comprising:
(a) a generator for generating a broadcast record related to a topic on the interactive show;
(b) a broadcaster for broadcasting the generated broadcast record; and
(c) an enabler enabling interaction with the broadcast record.

22. An apparatus for broadcasting a show over a network, comprising:
(a) a means for receiving a question related to the show;
(b) in response to the received question a means for creating a broadcast record that includes different forms of media;
(c) a means for broadcasting the broadcast record over the network;
(d) a means for enabling interaction with the broadcast record and the show; and
(e) a means for inserting an advertisement into the broadcast record.
